(19) United States
(12) Patent Application Publication
(10) Pub. No.: US 2021/0228007 A1
(43) Pub. Date: Jul. 29, 2021

(54) Stability Retainer Pick and Method of Its Use

(71) Applicant: C. Dudley Meadows, Signal Mountain, TN (US)

(72) Inventor: C. Dudley Meadows, Signal Mountain, TN (US)

(21) Appl. No.: 17/160,988

(22) Filed: Jan. 28, 2021

Related U.S. Application Data
(60) Provisional application No. 62/966,734, filed on Jan. 28, 2020.

(51) Int. Cl. A47G 21/00; A23P 20/20

(52) U.S. Cl. CPC A47G 21/00; A23P 20/20

(57) ABSTRACT

A stability pick for use with sandwiches has a. retainer having a handle with downwardly extending parallel prongs. The prongs can be curved and extend through a top covering surface of the sandwich and into, if not through, an at least semi-rigid material selected from the group of a meat, vegetable, fruit and cheese. The prongs may extend into a bottom covering layer for at least some embodiments. If curved, the curvature may assist in clamping the pick to the sandwich.

### CLAIM OF PRIORITY

This application claims the benefit of U.S. Provisional Patent Application No. 62/966,734 filed Jan. 28, 2020 which is incorporated herein by reference in its entirety.

### FIELD OF THE INVENTION

The present invention relates to an improved toothpick type structure and method of its use, and more particularly to a two pronged toothpick having parallel prongs which proceed through an upper bun or bread portion of a sandwich through an interior filling of the sandwich and preferably into a lower bun or bread surface whereby the filling, normally containing a meat and/or other at least semi-rigid material, is then anchored and prevented from twisting out of the bun or bread while eating.

### BACKGROUND OF THE INVENTION

Most people have experienced a sandwich come apart while eating. The contents may spill into their lap or along a shirt, This can be frustrating.

Toothpicks have been around for decades, if not centuries. Toothpicks are normally a longitudinally straight structure with pointed ends which can be individually employed to hold food such as sandwiches together.

Improvements to the basic toothpick design include U.S. patent application Ser. No. 2,070,976 which shows a Fruit Prong having non-parallel prongs for holding fruit along with a notch for retaining the pick structure on the side of a glass such as for martinis and the like. In this structure, the prongs are somewhat radially disposed so that the fruit such as olives etc., can be inserted onto the prongs without interfering with each other.

U.S. Pat. No. 3,772,809 shows a cocktail pick having a holding clip 2 and a blade 4 for stabbing the olive or other inserted food article. Meanwhile, a plaque or handle at upper end 3 can be utilized to display advertising. Advertising on plaques or handles is well known in the art for single linear toothpick constructions.

While forks have prongs, they are normally utilized to eat food rather than to insert into food while eating by hand from an end of a food.

Accordingly, there is believed to be a need for an improved pick or retainer for use with hand-held food, and more particularly for use with food that has a center portion which has a tendency to slide out from between bun or bread-like structure.

### SUMMARY OF THE INVENTION

It is an object of many embodiments of the present invention to provide an improved pick for use in holding filling internal to a bun, wrap or bread-like structures which preferably includes an at least relatively solid internal structure such as a patty, sandwich meat and/or other structure from not only sliding away from the eater out the back side of the structure, but also twisting at the structure.

It is another object of the present embodiment to provide an improved food pick and method of its use.

Accordingly, in accordance with many embodiments of the present invention, an improved pick is provided. For many embodiments the pick can be constructed of a molded, injected, stamped and/or cut piece of material such as plastic, metal, etc. which could possibly be substantially planar initially and formed to have two parallel extending prongs which are preferably similarly shaped which possibly bend in a curve along a length of the prongs in a similar manner. Although some embodiments could taper toward a point or blade, many embodiments provide relatively uniform cross section along the length of the prongs possibly all the way to the end.

Traditional toothpicks are not curved along their length. The improved pick or retainer provides prongs having opposing surfaces proceeding in a parallel manner and preferably provide multiple parallel prongs. The retainer can be inserted into a sandwich to assist in retaining material in a filling layer and/or others to assist in keeping it from sliding as well as twisting out.

### BRIEF DESCRIPTION OF THE DRAWINGS

The particular features and advantages of the invention as well as other objects will become apparent from the following description taken in connection with the accompanying drawings in which:

FIG. 1 is a top perspective view of a presently preferred embodiment of the present invention inserted into a sandwich;

FIG. 2 is a front plan view of the embodiment of FIG. 1;

FIG. 3 is a side plan view of the embodiment of FIGS. 1 and 2;

FIG. 4 is a perspective view of the embodiments of FIG. 1-3;

FIG. 5 is a bottom plan view of the embodiments of FIGS. 1-4;

FIG. 6 is a top plan view of the embodiments of FIGS. 1-4;

FIG. 7 shows the embodiment of FIGS. 1-6 inserted into a hamburger;

FIG. 8 is a side plan view of the embodiment shown in FIG. 7, with internal portions shown in phantom.

### DETAILED DESCRIPTION OF THE PREFERRED EMBODIMENT

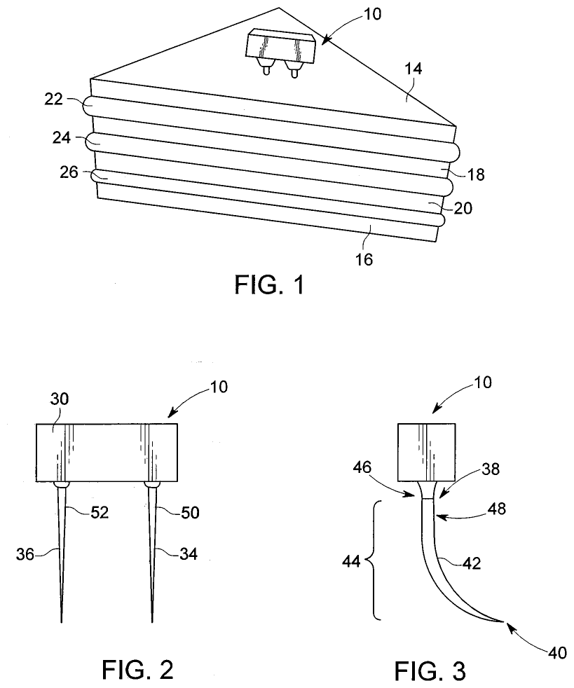

FIG. 1 shows a pick or retainer 10 inserted into a sandwich 12 such as a club sandwich having a plurality of bread layers such of at least top layer 14 bottom layer 16 and possibly one or more intermediate bread layers 18,20. Intermediate the bread layers such as 14,16 are one or more layers of filling such as filling layers 22,24,26. At least one of the filling layers 22,24,26 preferably has a meat or other at least semi-rigid material whether that be cheese, vegetables, fruit or other material which can be secured with a retainer 10 as will be described in further detail below.

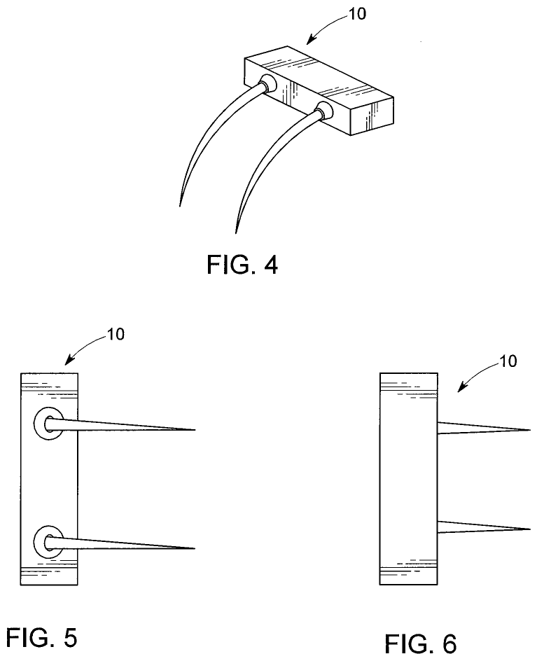

A sandwich will be defined as any food which can be hand held having an outer covering of bread, bun and/or wrap material above and below an interior filling layer. The retainer 10 is better shown absent the sandwich 12 in FIGS. 2-6. Retainer 10 has a plaque or handle 30 which may have an indicia 32 printed and/or formed thereon. Although the handle 30 is shown as being rectangle, any appropriate shape whether that conforms to a logo or other shape may be employed in various embodiments. Furthermore, although the handle 30 is shown being planar, it could be three dimensional as well for various embodiments.

From the handle 30 are preferably first and second prongs 34,36. First and second prongs 34,36 are shown parallel from their first end 38 to their second end 40 for many embodiments.

Additionally, the prongs 34,36 may be curved at least over a portion such as first portion 42 if not over their entire length 44, In many embodiments, the cross section of the prongs 34,36 is identical to one another across their length 44. Although it may be possible for prongs 34,36 to be pointed and/or tapered to a point and many embodiments the ends 40 may be blunt or even rounded.

As can be seen in reference to FIG. 3, the first and second prongs can be identical for many embodiments so that a front surface 46 of each may be parallel along with a rear surface 48 along the entire length 44 for at least some embodiments if not also parallel with a front and rear of the handle 30. As can be seen in FIG. 2 side surfaces 50,52 may be parallel and even identical to each other for prongs 34,36 for at least some embodiments. Prongs 34,36 may extend from a bottom surface 54 of the handle 30 to be connected at other locations to the handle 30.

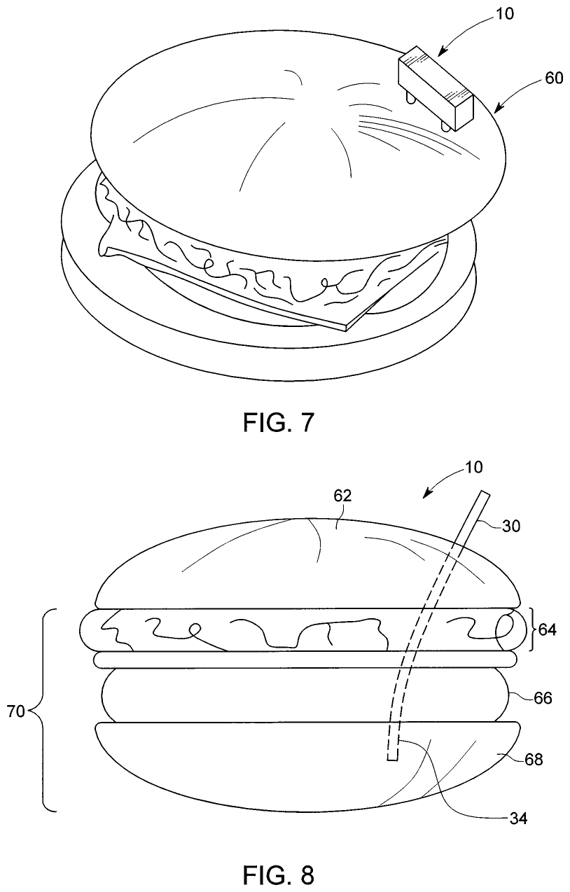

When using the pick or retainer 10, it is envisioned that will be utilized with food and more particularly with sandwiches 12 such as with a club sandwich type structure as illustrated in FIG. 1 or possibly a hamburger 60 (which also falls under the sandwich definition) as shown in FIGS. 7-8, or other sandwich, In these embodiments, the handle 30 has been grasped and the prongs 34,36 are pressed through the upper bun 62 through toppings 64 and/or a patty 66 and, possibly into, if not through, lower bun 68. Other embodiments may not have the prongs 34,36 extending into the lower bun 68 but may extend into the patty 66. Patty 66 need not necessarily be a hamburger made of beef but could also be a chicken sandwich, pork sandwich, fish sandwich or other patty 66 of various meat and/or vegetable products. The handle 30 is released with the retainer 10 at least assisting in retaining the sandwich 12 (or at least a portion) together, The retainer 10 can be removed once one has eaten close to it.

While some embodiments may provide linear prongs 34,36, the curved prongs 34,36 as illustrated in FIGS. 2-6 and others, have been found to effectively provide a damping action on the total height 70 of a sandwich of various constructions. This clamping action can assist the sandwich 60 from coming apart.

Unlike a traditional linear toothpicks utilized to hold a club, BLT, etc., together, the retainer 10 has multiple tines, such as first and second tines 34,36 which extend downwardly from a handle 30 into the sandwich 12,60 as illustrated in the embodiments, The prongs 34,36 restrict not only sliding of the filling layers such as patty 66 or layers 22,24,26 etc., if not internal bread layers 18,20 (or portions thereon if present etc., and/or filling or toppings 64 from sliding out the rear of the sandwich 60 when eating, but also by having multiple tines 34,36 twisting out is prevented as well by anchoring in multiple positions

Oil many occasions the fillings layers 22,24,26 if not the patty 66 and/or its topping 64 can. be relatively slippery as compared to the upper and It buns 62,68 if not upper and lower bread layers 14,16 etc. Some toppings 64 and/or condiments such as sliced: tomatoes, mayonnaise, ketchup, etc., may provide a slick surface onto which the internal toppings and/or layers (or portions thereof) and/or patties may tend to slide relative to the upper and/or lower buns 62,68 and/or bread layers 14,16, etc. The pick or retainer 10 can anchor the patty 66, filling layers 22,24,25, internal bread layers 18,20, if present, to prevent from exiting the sandwich 12 or 60 and/or twisting.

Numerous alterations of the structure herein disclosed will suggest themselves to those skilled in the art. However, it. is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A stability retainer pick for use with sandwiches comprising:
A retainer having a handle connected to first and second spaced apart and parallel prongs extending downwardly from the handle.

2. The pick of claim I wherein the prongs extend from a bottom surface of the handle.

3. The pick of claim 2 wherein the prongs are parallel to a front face of the handle at the connection to the handle.

4. The pick of claim 2 wherein the prong are parallel to a rear face of the handle at the connection to the handle.

5. The pick of claim 4 wherein the prongs are parallel to a front face of the handle at the connection to the handle.

6. The pick of claim 5 wherein the prongs are curved along their entire length.

7. The pick of claim 6 wherein the prongs have identical cross sections to one another along their length.

8. The pick of claim 7 wherein the prongs taper toward ends opposite the prongs from the handle.

9. The pick of claim 1 in combination with a sandwich having a top and a bottom covering layer with at least a semi--rigid material therebetween selected from the group of meat, vegetable, fruit, and cheese, and
the pick extends through the top covering layer into the at least the semi-rigid material thereby retaining the semi-rigid material relative to the top covering layer and resisting twisting of the at least the semi-rigid material relative to the top covering layer.

10. The pick of claim 9 wherein the pick extends completely through the at least the semi-rigid material into the bottom covering layer.

11. The pick of claim 1 wherein the handle has indicia thereon.

12. A method of using a stability retainer pick with sandwiches comprising the steps of:
a) providing a stability retainer pick having a handle with first and second spaced apart and parallel prongs extending downwardly from the handle;
b) directing the prongs of the pick through a top covering layer of a sandwich and into at least a semi-rigid material selected from the group of meat, vegetable, fruit, and cheese, and
c) beginning to eat the sandwich with the pick connected to the sandwich assisting in preventing the semi-rigid material twisting or moving relative to the top covering layer.

13. The method of claim 12 wherein the prongs extend through the at least semi-rigid material and into the bottom covering layer.

14. The method of claim 12 wherein the prongs are curved along their length while supporting the handle perpendicularly to the top covering layer when installed to assist in providing a clamping action.

15. The method of claim 12 wherein the prongs in the provided step are parallel at front and rear surfaces of the prongs along their entire length.

16. The method of claim 12 wherein the prongs in the provided step are parallel to a front and rear of the handle where connected to the handle.

17. The method of claim 12 wherein the handle has indicia thereon which is displayed while the pick is connected to the sandwich.
